(19) United States
(12) Patent Application Publication
(10) Pub. No.: US 2016/0342957 A1
(43) Pub. Date: Nov. 24, 2016

(54) AIR HANDLING UNIT FILTER REPLACEMENT SYSTEM AND METHOD

(71) Applicant: CHARLES J. SLOUP, OMAHA, NE (US)

(72) Inventor: CHARLES J. SLOUP, OMAHA, NE (US)

(21) Appl. No.: 15/162,355

(22) Filed: May 23, 2016

Related U.S. Application Data
(60) Provisional application No. 62/165,264, filed on May 22, 2015.

(51) Int. Cl. G06Q 10/00; G05B 23/02; G06Q 30/02; G06Q 50/06; G05B 13/04

(52) U.S. Cl. CPC G06Q 10/20; G06Q 50/06; G05B 13/048; G06Q 30/0226; G05B 23/0254

(57) ABSTRACT

A building air-handling unit (AHU) total cost of operation optimization method includes the steps of providing a mathematical model of the AHU, obtaining weather information and electricity pricing information and labor and material costs for filter replacement, reading the AHU airflow (AF), prefilter pressure drop (PFPD), and final filter pressure drop (FFPD) of the respective Air Handling Unit (AHU), periodically transferring the AF, the PFPD, and the FFPD to an optimization system which is operative to analyze the data in coordination with the mathematical model by assigning at least three selected values in a range surrounding and including the current values of each of the projected prefilter and final filter replacement dates and calculating the efficiency profile of the component of the air-handling system for each of the selected values, then cooperatively optimizing and selecting those values calculated to provide the highest efficiency profile, then periodically resetting the filter replacement dates to those selected by the optimization system.

### BACKGROUND OF THE INVENTION

1. Technical Field

The present disclosure is directed to the optimization of air-handling unit electricity use (or total cost of ownership) and, more particularly, to an improved optimization configuration whereby the building automation system and/or Automated Fault detection system providing time series data, a mathematical model which integrates both basic engineering formulas and regression results, and an optimization engine work in concert with one another to examine variables relating to filter replacement and cooperatively optimize those variables to generate replacement dates for the filter maintenance to reduce the Air Handling Unit operational costs and increase the operating efficiency of the Air Handling Unit.

2. Description of the Prior Art

The need for more efficient and sustainable buildings has grown as the number of buildings being built and renovated continues to rise in the presence of sharply rising energy costs. Building owners react to increasing utility costs by demanding better designs from engineering professionals yet standard practice has inherent limitations to the overall benefit that can be provided building owners. Accordingly the HVAC industry has attempted to develop HVAC optimization systems and techniques that allow the building owner to reduce energy costs, a long felt need which has yet to be fully addressed.

The prior art discloses that current filter replacement optimization techniques are available within Global (whole building) Optimization Systems. (U.S. Pat. No. 7,894,943 B2, 2011). Acquisition of optimized filter replacement information is one of many features of these global optimization systems and therefore cost of implementation is spread over many features. The same prior art experiences implementation challenges which are much the same as the challenges of implementing comprehensive facility analytics in the form of Automated Fault Detection and Diagnostics (AFDD) are:
a) Ability of older building automation systems to generate and export significant number of high frequency data points without experiencing a slowdown of performance.
b) Significant variation between various owners and building automation contractors with regard to points that are monitored in a BMS.

Therefore an object of the present invention is to reduce the number of data points that must be gathered from the Building Automation System to a minimum of 1 data point on 5 minute intervals and 2 data points that must be gathered on 1 week intervals for each AHU. Another object of the present invention is to provide a variety of alternative techniques for gathering the above mentioned 3 data points when not directly measured by the BAS. In other words the creation of virtual data points. In other words if the BMS systems are restricted in their capacity to transfer data the most cost effective stand alone measures need to be implemented. If filter optimization techniques are the only information required or requested by a customer the return on investment on setup costs becomes less attractive because not all variables are required for this particular element of the calculation. Therefore there is a need for a simplified model that only utilizes the minimum amount of information necessary to make the decision. There is also the need to gather such data in the most cost effective way possible. The ability to carve out this particular element out of a system with many elements that are interrelated will sacrifice the efficacy of the Global optimization technique. The underlying premise of the whole Global optimization concept however there may be technical as well as financial reasons why partial implementation may be better than global. Such as the fact that there are certainly challenges associated with integrating to older BMS systems to get the Calibration data for the model.

The prior art discussion immediately above outlines the “technical” reasons why a stand alone filter optimization scheme is necessary but there are also psychological considerations of such global optimization effort. The challenges of implementing Global Optimization are consistent with the challenges of implementing comprehensive facility analytics in the form of Automated Fault Detection and Diagnostics (AFDD) are:
a) Some implementations of AFDD encounter resistance by the facility's Building Automation System contractor who may be threatened by a non-traditional player in the owner/contractor relationship, especially one that reports on system performance.
b) Some implementations of AFDD encounter resistance by the facility staff who may be threatened by a non-traditional player inserting themselves into the operation of the facilities department, especially one that reports on system performance.

Therefore an object of the present invention is to provide a valuable service that does not question the competence of either the local BAS contractor or the facility staff as traditional AFDD analytics could possibly be perceived but rather introduce an analytic technique that has enough elements of “Utility” engineering that they do not feel imposed upon. But rather Utilities are sufficiently “high tech” or separate from the HVAC industry so it is not considered as a part of industry standard practice but rather above and beyond a feature that could “conceivably” be executed into a BAS system. Another object of the present invention is to provide a service that requires very little in terms of “follow up” by the facility staff. Achieving benefit with very little effort in terms of follow up meetings. Service after the sale is minimal, only reporting of aggregated savings.

The prior art discloses that current filter replacement optimization techniques are available within Global (whole building) Optimization Systems. (U.S. Pat. No. 7,894,943 B2, 2011). The primary focus of such systems are to Optimize for Current conditions therefore there is an emphasis on historical data generated from realtime monitoring. However since filter optimization has a longer window of optimum projection historical data generated from realtime monitoring may introduce errors from variations in weather patterns. Therefore it an object of the present invention to utilize weather data from “normalized” weather files, similar to those utilized by Design Engineers. In fact the above referenced patent utilizes such weather files to project the effectiveness of the global optimization techniques before the building is built. The danger of using strictly historical weather files is that one summer may be cooler than normal and the next is warmer than normal may represent a significant deviation of results. However if the use was “normalized” by a recognized authority such as DOE then there is the potential of less deviation. There is a need for the strictly historical files though. These files can be run in addition to the normalized file in order to determine the risk of a particular recommendation.

The prior art discloses that other current filter optimization techniques utilized by Filter manufacturers focus on optimization of electric consumption, KWH, or a blended electric rate of total electric cost divided by total consumption in KWH. This is evidenced by the entry of a single, “average” cost of KWH into filter selection software programs. While this is acceptable for quick calculations or “one size fits all” approach, there are inherent problems in this approach which do not fully address and solve the need for optimization and efficiency demanded in today's market. For example, the prior art approach described above will result in demand costs being assigned to bills in the spring, fall and winter when in fact they are usually associated with the summer peak. Another example that highlights the contradiction of average cost vs time sensitive cost is when filter replacements are driven by schedule or reaching a predetermined (sometimes arbitrary) differential pressure setpoint across the filter, and neither the schedule or differential pressure setpoint changes even though utility rates are changing based on time of year and environmental conditions. The nuances of electric consumption and demand charges in rate structures that the customers see and the Location Marginal Price (LMP) that the utilities see in real time will be discussed in the “Preferred Embodiment” section of the patent.

Therefore, there is a need for a detailed and integrated view of each element of the AHU fan energy consumption profile that is appropriately adjusted for time and environmental criteria as well as the labor and purchase costs associated with a filter replacement. The system must also have the capability to any HVAC system configuration and yet is independent of proprietary features of a specific manufacturer's equipment.

The prior art also discloses a variety of techniques for electric load shifting from day to night, such as thermal storage by electricity users and Utility Scale Energy Storage by electricity generators. When it comes to longer charge and discharge cycles there is the opportunity for both users and generators to implement Seasonal Thermal Energy Storage (STES) systems. However these techniques have much lower adoption rates due to capital costs, complexity and ability to be widely applied. All of these techniques are fundamentally different than what is shown in the present invention because of the amount of additional physical devices necessary to make them work when compared to a base case (completely different systems). These techniques differ in concept from the present invention. Prior research has shown that these techniques can successfully save energy for both users and generators but the present invention will not feature or discredit them. Historically, the building and electricity generation industry has not widely accepted load shifting and energy storage, but its usability was not examined here due to the basic difference in approach as compared to the present invention. It is an object of the invention be an improved and relatively simple method of shifting load from summer to winter in order to take advantage of lower energy costs in winter and utilize electric energy that has a higher renewable (wind) content.

The feature of shifting load from summer to winter, as described immediately above also has the benefit of increasing the capacity and/or increasing the runtime of on site emergency generators. For example the core feature of the proposed patent is to lower peak demand, lowering peak demand on a generator with fixed capacity essentially increases the load that the generator can carry or increases the runtime of such a generator if partially loaded. This is only possible by shifting load to outside the generator operating window, which is generally 24 to 48 hours which would prevent daily load shifting from providing such a benefit. Additional generator capacity requirements is a longtime issue in many types of mission critical facilities, such as new additions to healthcare facilities and or facilities such as data centers that have increasing load density over time.

### SUMMARY

The present invention provides a building air-handling unit (AHU) total cost of operation optimization method, including the steps of providing a mathematical model of the air handling system including at least an efficiency profile of the components of the air handling system, a filter loading profile, a fan airflow profile, and obtaining real time weather information including at least outside temperature and outside humidity, obtaining normalized historical weather file, filter replacement history, labor and material schedule and electric cost from electric rate engine or real time pricing data. Both of these electric costs shall reflect production tax and renewable energy credits. The next step would involve the reading of the prefilter change date and the final filter change date of at least 1 AHU, stored in the calculation engine and transferring the preprocessed files collectively to an optimization system, the optimization system operative to analyze the input data in coordination with the mathematical formulas by assigning at least three selected values in a range surrounding and including the current values of each independent variable.

### BRIEF DESCRIPTION OF THE DRAWINGS

FIG. 1 is a flow diagram of a system according to the present invention.

FIGS. 2 and 3 are baseline and optimized differential pressure graphs showing how the present invention drives an air handling unit to reduce peak demand by decreasing pressure

FIG. 4 is a series of fan curves at various RPM. Showing relationship of RPM to Static Pressure.

FIG. 5 Example of raw filter pressure drop data.

FIG. 6 Example of raw fan airflow data.

FIG. 7 is the tracking of average wind speed when comparing summer and winter.

### DETAILED DESCRIPTION

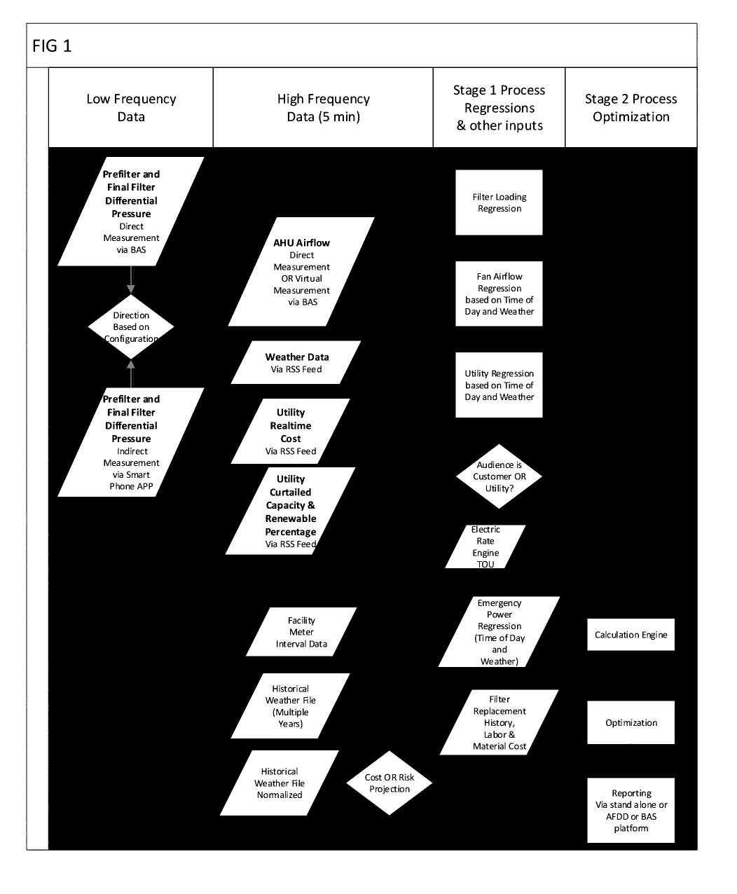

The improved optimization configuration of the present invention is best shown in FIG. 1 as including a building automation system and alternate data gathering techniques, energy calculation engine and optimization engine working in concert with one another.

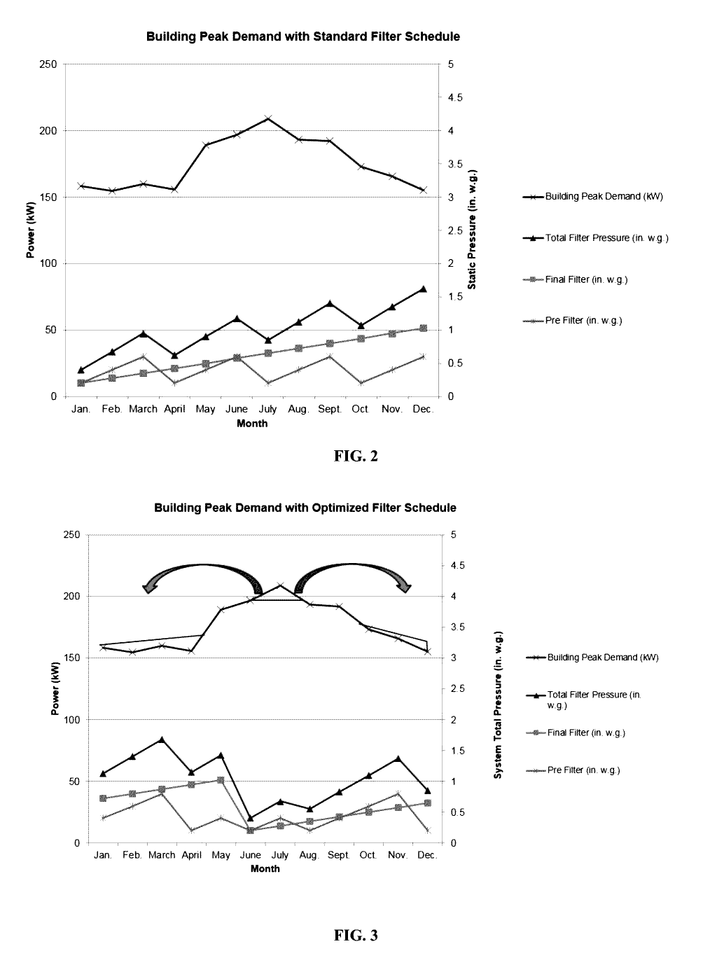

The results of implementing the improved optimization configuration of the present invention is best shown in FIGS. 2 and 3. FIG. 2 is the baseline electric demand curve. FIG. 3

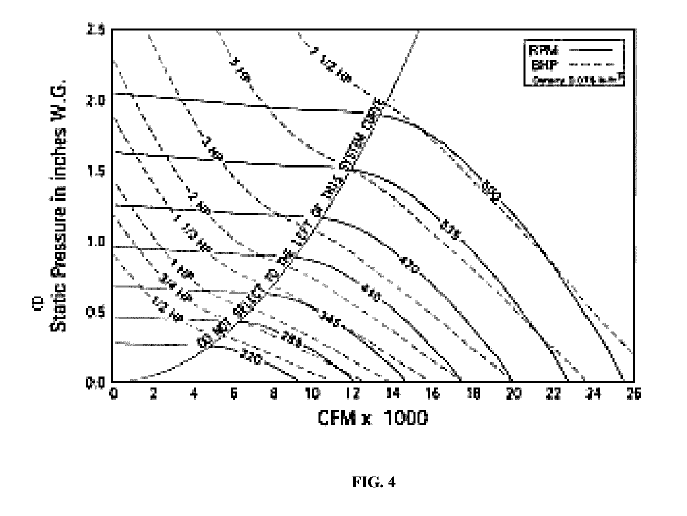

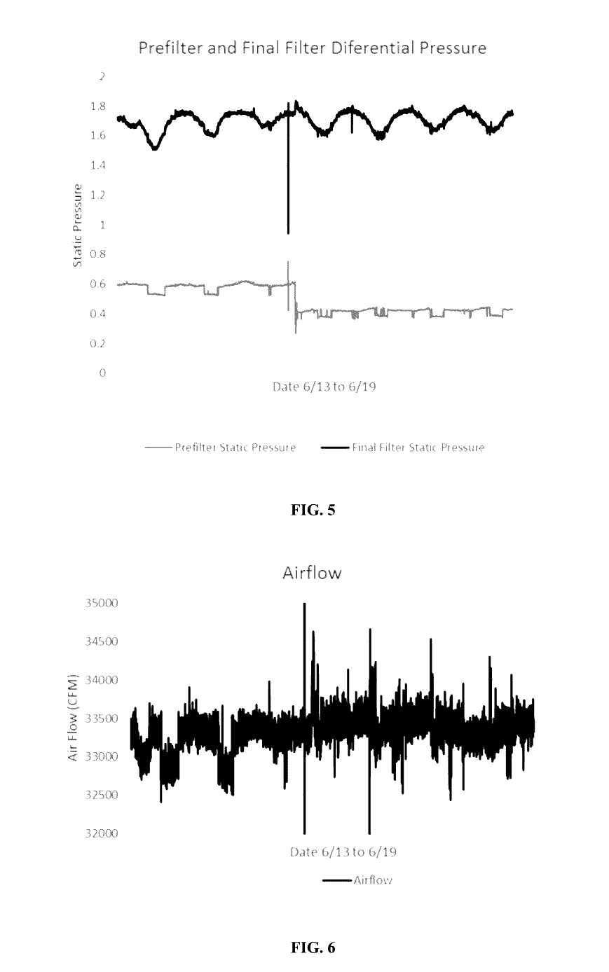

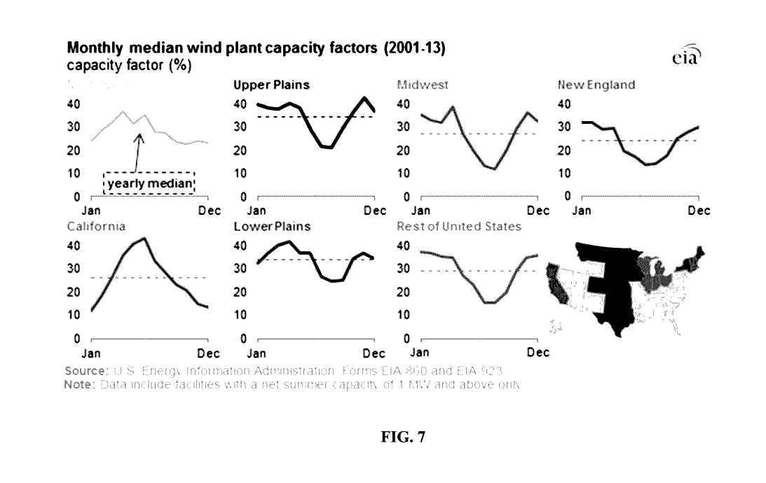

Is the optimized electric demand curve.
1) Building Automation System (BAS) and/or data gathering platform associated with Automated Fault Detection and Diagnostics (AFDD) Platform.
   A) In general, a BAS is a Direct Digital Control (DDC) system utilizing sensors/actuators/controllers/operator workstation and network to tie all the elements together as is the industry's standard of care. This network will either incorporate a computer on site to perform the optimization calculations or include a gateway to the internet for access to an offsite computer to perform the optimization calculations. Of course the exact configuration of this linkage is not critical to the present invention so long as the functionality of the present invention is not degraded. The basic configuration can be applied to all control system manufacturers.
   B) In general an AFDD is an Automated Fault Detection and Diagnostic Platform utilizing data stored generated by a BMS and transferred to a data gathering/storage platform to perform screening and sorting of data to detect anomalies in the operation of the building mechanical systems. While AFDD and the present invention may both be considered, “building analytics” in the broadest of terms the present invention is distinctively different in its use of advanced techniques of pattern recognition (regression) and optimization which involves testing of “possible” situations which traditionally have not been utilized by AFDD providers. Depending on the make and model and vintage of the BMS the AFDD platform is connected to the AFDD offer enhanced ability to store high frequency data for long periods of time.
   C) Building Automation System (BAS) and Automated Fault Detection and Diagnostics (AFDD) platform are used interchangeably in this discussion because each is theoretically capable of performing the necessary tasks but may or may not actually be able to do so based on configuration by the respective contractors, and age of the equipment. For example an AFDD may be used when an older BAS is required to store data for long periods of time.
   D) The BAS will transfer current building operation characteristics such as weather and equipment operational characteristics such as AHU airflow to the optimization preprocessor. This is a nontraditional feature for the controls contractors yet should be relatively easy to implement.
   E) The BAS may also receive the recommendations of the optimization Engine. This likewise is a nontraditional feature for the control contractor.
   F) The majority of the BAS or AFDD Platform configuration would be of the standard type used in the prior art but a critical feature of the present invention is the ability to substitute “virtual data points” when the hardware does not exist to measure the 3 critical variables on each AHU directly. Those variables are AHU flow as well as Prefilter and Final Filter Differential Pressure and/or tertiary filtering such as terminal HEPA's. It should be noted however that alternate methods of directly measuring flow and differential pressure are known to those skilled in the art of building control system, but the inclusion of the alternative reading methodologies is believed to be inventive in nature and is important feature of the present invention.
      Virtual AHU Airflow Calculation Method #1: In the absence of direct measurement of AHU airflow at the AHU itself, the sum of all of the Air Terminal Unit Airflow sensors may be used as a substitute.
      Virtual AHU Airflow Calculation Method #2: In the absence of direct measurement of AHU airflow the combination of gathering the fan RPM as reported by the VFD via the BMS and the addition of a differential pressure sensor across the supply fan will yield fan flow. Once the two variables are known they are inserted into a polynomial curve appropriate for the RPM, generated based on fan manufacturers data as per FIG. 4. The calculation of airflow can be accomplished at the BMS the AFDD platform or in the Optimization calculation, where ever it is convenient.
      Virtual Differential Pressure Calculation Method #1: When BAS is configured with a differential pressure gauge with binary output that indicates when differential pressure has met a specific setpoint. The setpoint on the gauge shall be set at intermediate points and when the point is detected as being met it is so noted by the system and the setpoint is raised in the field to a new intermediate setpoint. The setpoint is not the final replacement pressure as traditionally configured.
      Virtual Differential Pressure Calculation Method #2: When BAS is not connected to filters in any way it is possible to measure the pressure gauge 1 time per week and match it up with concurrent AHU airflow and through a calculation come up with a virtual pressure drop at the higher time frequency. The measurement of 1× per week would be done during maintenance department “rounds” using custom designed smartphone app that would streamline data acquisition. Each gauge not hooked to the BMS would receive a QR or Barcode at the project setup. Once scanned during “rounds” the code would bring up a form for the maintenance technician to enter the current pressure reading. This reading would then be transferred to a database capable of being uploaded to the filter loading curve preprocessing element.
      Virtual Differential Pressure Calculation Method #3: When BAS is not connected to filters in any way but has a digital readout it is possible to measure the pressure gauge by taking a picture of the gauge with a smartphone and then doing image processing to read the QR or bar code to get the meter metadata and have an Optical Character Recognition Software to batch process the images to read the values.
      Virtual Differential Pressure Calculation Method #4: When BAS is not connected to filters in any way but has an analog readout it is possible to measure the pressure gauge by taking a picture of the gauge with a smartphone and the doing image processing to read the QR or bar code to get the meter metadata and also have the image processor to batch process the images to read the gauge. Image processing can be accomplished using a variety of methods including Hough transform or reverse image lookup.
   G) Weather Data from an offsite Weather Station via RSS feed or other means may be provided to a BMS or an AFDD platform. It is important to have true “weather station” data in lieu of BMS data because weather station data is more closely aligned with historical weather field used for projection into the future. For example, an OAT sensor that is mounted on a rooftop AHU may have temperature measurements influenced by the black rooftop. Whereas weather stations have specific criteria regarding environmental influences. Weather stations also tend to have better calibrated equipment. For example inexpensive RH sensors used in BMS system have calibration issues whereas true weather stations may have real dew point sensors which are much more expensive but also much more accurate. Weather station will also have additional data such as wind readings where an individual building would not have such data.
   H) Utility realtime cost of electricity may be provided via RSS feed, API, or other means to a BMS or an AFDD platform.
   I) Utility realtime percentage of electricity derived from renewables such as a wind or solar breakout and curtailed generating capacity data may be provided via RSS feed, API, or other means to a BMS or an AFDD platform.
   J) Facility Meter Interval Data may be provided via RSS feed, API, or other means to a BMS or an AFDD platform.
2) Simulation
   A) General Description. The relationship of the simulation program to the other components can best be seen in figure #1 of this disclosure. Of course the modifications to the design of the simulation program and the interface with the optimization program and the building automation system is well within the purview of the present invention but it has been found that the configuration disclosed is well suited to the present use wherein computing load is external to the building automation controllers.
   B) Preprocessing: Filter Loading Profile: The result of the analysis is to determine the slope of the differential pressure, normalized for airflow, across the prefilter and the final filter and any tertiary filters such as HEPA's vs time and express it as a polynomial equation. This profile is likely to be different for each air handling unit due to its unique filter selection or combination of filter selections and configuration within the AHU, if the unit is oversized (therefore low velocity), turndown ratio's, if the filters get wet due to cooling coil condensation migration downstream and a variety of other factors. If the facility is just coming online library values can be used for gross approximation of optimal filter change times. Empirical data specific to the specific unit can provide additional insights. Excel is being used for proof of concept development however alternative programming technologies will probably be used for large scale implementations and more efficient/robust operation.
   This will be accomplished with the following steps.
      a. If the filter differential pressure is not measured directly by BMS, obtain the low frequency indirect measurements via Virtual Differential Pressure Calculation Method #1-#4 described in the BMS section of the preferred embodiment section.
      b. The indirect measurements from “a” above will have their timestamps matched up to the AHU—Airflow high frequency data to come up with a raw pressure drop value that is much lower frequency than direct measurement.
      c. Raw pressure drop values taken from indirect measurement steps a and b above OR directly measured by the BMS as shown in FIG. 5 have not been normalized for flow. However calculation utilizing the fan affinity laws can be used to adjust for a “normalized flow, anywhere between min airflow and max airflow. FIG. 5 shows a filter pressure profile over many months. The sudden pressure drops indicate that filters were replaced with new filters.
      d. After being normalized for flow and filter replacement events, graphs will then have a trendline imposed over the top of the data, with the associated polynomial and R squared coefficient.
      e. This polynomial equation will then be transferred to the Calculation engine for implementation on time series data.
   C) Preprocessing: Fan Loading Profile: The result of the analysis is to determine a daily airflow profile in a variable volume system vs time or volume vs OA temperature and express it as a polynomial equation. Analysis has revealed that it is necessary to have a profile for each hour of the day due to the fact that some units shut off at night rather than run 24/7. There is also a need to have a profile for weekdays and weekend due to the fact that some units are will shut down during the weekend rather than run 7 days a week. There is also the consideration that in some climates that are closer to equator there is less seasonal variation therefore volume would be compared to time not OA temperature. If the simple regressions described above do not yield a sufficient degree of accuracy then it will be necessary to use neural network modeling that integrates many different variables.
   The distinct advantage of using regressions and the reason for making it the preferred embodiment is that small samples can yield trends that can be projected with a reasonable degree of accuracy and only improve the more data is obtained. Whereas long term data trends while viable have the downside of waiting for results.
   This profile is likely to be different for each air handling unit due to its unique building load profile (solar, shading by adjacent buildings, people, equipment lights). If the facility is just coming online library values can be used for gross approximation of ahu airflow profiles. Empirical data specific to the unit can increase the accuracy and provided for revenue grade savings calculations.
   Fan Airflow is considered a high frequency data. The reason 5 minute interval data is chosen is so the Fan Airflow will match the highest frequency realtime electric costs and no interpolation would be required. The data frequency could be reduced if realtime electric costs are settled on longer intervals or realtime costs will not be calculated. Excel is being used for proof of concept development however alternative programming technologies will probably be used for large scale implementations and more efficient/robust operation.
   This will be accomplished with the following steps.
      a. If the AHU airflow is not measured directly, either obtain summation of the ATU's or obtain the fan RPM and fan differential pressure reading via Virtual Airflow Calculation method #1 and #2 described in the BMS section of the Preferred embodiment section.
      b. Each airflow profile will have a trendline imposed over the top of the data, with the associated polynomial and R squared coefficient.
      c. This polynomial equation will then be transferred to the Calculation engine for implementation on time series data
   D) Preprocessing: Electric Rate Engine:
   The purpose of this calculation is to provide the simulation engine a cost of energy on the same time interval that the fan energy is being calculated in order to calculate a total cost expressed in currency. Energy costs are typically presented as blocks of time, hence the label, Time of Use (TOU) rates. But these times need to be converted to costs at a specific timestamp in order to be compatible with the time series simulation calculations. There is not a one size fits all electric rate engine. Some rates put the priority on consumption costs while others put the emphasis on demand costs. The Electric rate engine will be used in the base simulation. In other words the simulation that the end customer would see. This is not to be confused with the real-time electric costs that the Utilities see.
   Excel is being used for proof of concept development however alternative programming technologies will probably be used for large scale implementations and more efficient/robust operation.
   E) Preprocessing: Filter Replacement History, Labor and Material Schedule:
   The purpose of this calculation is to provide the simulation engine a cost of labor and material for a specific filter replacement in order to calculate a total cost expressed in currency. Labor costs would be gathered either in cost per filter and filters per AHU or cost per AHU for replacement. The intent would be to cover costs from acquisition to disposal. Material costs would be gathered either in cost per filter and filters per AHU or cost per AHU for replacement.
   Another purpose of this calculation is to establish the baseline of past operational practices. Such as historical profile of replacement of filters. This accomplishes two things it gives the baseline pressure profiles over time to compare the new pressure profiles against. This comparison will generate the “savings” number in the calculation. This will also provide a baseline labor and material cost to compare the new pressure profiles against. For example even though it takes labor and material to change filters an extra time during the year it may produce greater energy savings or generator capacity increases which are valuable to the owner.
   Excel is being used for proof of concept development however alternative programming technologies will probably be used for large scale implementations and more efficient/robust operation.
   F) Preprocessing: Historical Weather File (Normalized):
   These files are identical to those utilized by design Engineers when creating an energy model to size equipment. These “normalized” weather files mitigate the danger of using strictly historical weather files in that one summer may be cooler than normal and the next is warmer than normal may represent a significant deviation of results. However if the use was “normalized” by a recognized authority such as DOE then there is the potential of less deviation and consistency among results. These weather files which represent thousands of locations throughout the world are available to download off the DOE website.
   G) Preprocessing: Historical Weather File (Raw):
   These files are just records of weather with no adjustments for extremes of weather as described in the paragraph immediately above. In theory these files could be generated by taking the realtime weather data described previously and creating create a running file. However this assumes that data acquisition is perfect which rarely happens. So the alternative is to download an annualized weather file on a periodic basis that has been, scrubbed to provide data that is as consistent quality (but not content) as the Normalized Weather File.
   The normalized weather file will be used in the “Base” calculation of optimized filter replacement as described in prior art discussion. The raw historical weather file will be used to assess the risk associated with the filter replacement recommendation.
   H) Preprocessing: Real-time electric cost profile for a particular site:
   The result of the analysis is to determine a real time electric cost profile and express it as an equation. Analysis reveals the best correlation found so far is Real-time price vs hour of the day and Enthalpy. These regressions will continue to be refined due to the changing profile of the electric industry due to the EPA's Clean Power plan and State Renewable Portfolio mandates. As renewable energy percentages increase regional average wind speed and cloud cover may need to be intetrated into the equation. There may also be a need to have a profile for weekdays and weekend due to the fact that some locations are will shut down during the weekend rather than run 7 days a week. There is also the consideration that in some climates that are closer to equator there is less seasonal variation therefore demand profiles may only be daily as opposed to seasonal and daily.
   Analysis indicates that simple regressions will not yield a sufficient degree of accuracy, it is necessary to use neural network modeling that integrates many different variables simultaneously.
   This profile may be different for each building site due to various generators and transmission restrictions.
   The intent of this feature is to let either the utility know its true costs in order to facilitate mass customization of incentives or to identify the difference between actual costs and rate structures to give end users the knowledge to bargain effectively with the electricity supplier. This feature it provides for revenue grade savings calculations.
   The electricity real-time costs will be gathered at their clearing frequency which will then drive the frequency of other data collection.
   Neurodimensions Software is being used for proof of concept development and will probably be used for large scale implementations and more efficient/robust operation. This will be accomplished with the following steps.
      a. The Utility Realtime cost is gathered directly from the utility or ISO.
      b. The realtime cost will then be calculated along with other variables such as temperature, time of day, day of week, wind and cloud cover etc. in order to generate a profile.
      c. Each cost profile will have a polynomial equation generated in order for it to integrate with the energy/cost calculation engine.
      d. This polynomial equation will then be transferred to the Calculation engine for implementation on time series data
   I) Preprocessing: Utility Renewable Percentage & Curtailed Renewable Capacity
   The result of the analysis is to determine if there is an opportunity to overlay on top of the Utility Realtime cost or TOU rate engine with additional cost considerations, such as availability of production tax credits, renewable energy credits or carbon credits when performing an optimization and express it as an equation.
   The second benefit is to identify to the utility customer the increase in renewable energy they have achieved by taking this action.
   There will also be a need to have a profile for weekdays and weekend due to the fact that some utility loads will shut down during the weekend rather than run 7 days a week thereby creating lower demand. However in regions with discernable seasons, reports by the National Renewable Energy Lab FIG. 7 clearly indicate that in the USA wind energy has a higher generation rate in the winter than in summer.
   It appears simple regressions will not yield a sufficient degree of accuracy, it is necessary to use neural network modeling that integrates many different variables simultaneously. This profile is likely to be different for each building site due to various generators and transmission restrictions.
   The intent of this feature is to identify the difference between using electricity in the summer vs some other time of the year in order to match the increased renewable, wind, capacity with increased load. Which in turn should allow for acquisition of credits either directly or indirectly through electricity markets which in turn makes this technology more effective. It is the intent of using high accuracy calculation methods to provide for revenue grade savings calculations.
   It is anticipated, though currently not available, that the curtailed capacity can be gathered at the same frequency as the realtime costs however since this is a unique request of large entities the information may be available in other forms. Neurodimensions Software is being used for proof of concept development and will probably be used for large scale implementations and more efficient/robust operation. This will be accomplished with the following steps.
      a. The Utility renewable percentage gathered directly from the utility or ISO.
      b. The Utility curtailed capacity information gathered directly from the utility or ISO.
      c. Assuming renewable generators are willing to pay for this load when capacity is curtailed (but not peak demand) increase which increases the financial viability of the installation. Renewable credit would be issued via the generator by bidding into the electric market.
      d. Each credit profile will have a polynomial equation generated in order for it to integrate with the energy/cost calculation engine.
      e. In the absence of generator credits carbon credits can be calculated and processed by the end user or their energy supplier.
      f. This polynomial equation will then be transferred to the Calculation engine for implementation on time series data
   J) Preprocessing: Emergency Power Regression: The result of the analysis is to determine a daily on site generator profile on a facility wide basis, vs time or load vs OA temperature and express it as a polynomial equation. If the simple regressions described above do not yield a sufficient degree of accuracy then it may become necessary to use neural network modeling that integrates many different variables.
   The distinct advantage of using regressions and the reason for making it the preferred embodiment is that small samples can yield trends that can be projected with a reasonable degree of accuracy and only improve the more data is obtained. Whereas long term data trends while viable have the downside of waiting for results.
   This profile is likely to be different for each generator due to its unique building load profile (equipment lights). If the facility is just coming online library values can be used for gross approximation of generator profiles. Empirical data specific to the site can provide greater accuracy allowing for revenue grade savings calculations.
   Facility Meter Interval Data is considered a high frequency data.
   Excel is being used for proof of concept development however alternative programming technologies will probably be used for large scale implementations and more efficient/robust operation.
   K) Processing:
   The purpose of this calculation is to provide a total cost by integrating the various preprocessed elements, described above. The following are the various processing modes. The processing node will also store the filter change dates which are the output of the calculation.

| | | | | Option #3 | Option #4 |
|---|---|---|---|---|---|
| | | Option #1 | Option #2 | Utility | Generator |
| | | Utility (Real | Base with | Savings with | Capacity or |
| | | Time Electric) | Renewable | Renewable | Runtime |
| Mode | Base | Savings | Credit | Credit | Increase |
| Filter Loading | X | X | X | X | X |
| Profile | | | | | |
| Fan Airflow | X | X | X | X | X |
| Profile | | | | | |
| Electric Cost | X | | X | | |
| Rate Engine | | | | | |
| Electric Cost | | X | | X | |
| Realtime | | | | | |
| Electric | | | X | X | |
| Renewable | | | | | |
| Credit | | | | | |
| Labor and | X | X | X | X | X |
| Material | | | | | |
| Normalized | X | X | X | X | X |
| Historical | | | | | |
| Weather | | | | | |
| Emergency | | | | | X |
| Power Profile | | | | | |
| | Rerun with | Rerun with | Rerun with | Rerun with | Rerun |
| | raw historical | raw historical | raw historical | raw historical | with raw |
| | weather | weather | weather | weather | historical |
| | indicates | indicates | indicates | indicates | weather |
| | calculation | calculation | calculation | calculation | indicates |
| | risk | risk | risk | risk | calculation |
| | | | | | risk |

The core of the calculation engine is the fan energy equation, the fan affinity laws and the interface to the various preprocessed elements.
Calculation of the Filter Changeout recommendation will take place with 1 hour data.
Calculation of the “Realized Savings Revenue stream will take place based on electric cost frequency. But will take place in batches.
Excel is being used for proof of concept development however alternative programming technologies will probably be used for large scale implementations and more efficient/robust operation.
3) Exemplary Optimization
   1. General description: The relationship of the optimization engine to the other components can be found in FIG. 1. Of course the modifications to the design of the optimization program and it's interface with the building automation system as well as the simulation program is well within the purview of the present invention, but it has been found that the configuration disclosed is well suited to the present use wherein computing load is external to the building automation controllers.
   2. Optimization engines are more efficient in terms of computing resources. For example every possible combination of dates could be calculated which would take quite a bit of computing power. So by utilizing an optimization engine specifically designed for optimization in an efficient manner the results can be found quicker and with less computing resources. This is not a problem in a small scale implementation but if the system needed to scale this would be important.
   3. Optimization engines are typically utilized in academic or other types of research, with some products being better suited for certain applications than others. Optimization engines however, are generally not familiar with consulting engineers, building owners and contractors as a whole. The utilization of an optimization application program (engine) acting as a template reduces the need for the labor intensive development of a custom application.
   4. With that in mind the preferred embodiment utilizes an optimization engine called Solver and has the ability to interface with the software used in the proof of concept excel. This program was chosen for several reasons, but most significant reason is that it has a migration path from working on an individual workstation to working on Microsoft's Azure Cloud based platform.
   5. How it works:
      a. Information from the calculation elements (both preprocessing and core processing) are pulled into the optimization interface simulation input template.
         i. The number of independent variables is limited by actual operating conditions based on configuration. For example the independent variables being evaluated are prefilter replacement dates and final filter replacement dates.
         ii. The range of the independent variables is limited in order to reduce processing time.
         iii. It is at this stage that underlying constraints, such as system capacities, are taken into account. Boundaries (box constraints) can be imposed on the independent variables as well as dependent variables being limited by penalty or barrier functions as a result of programming.
      b. Optimization is performed:
         i. The optimization engine automatically writes the input files for the simulation. The generated input files are based on the input template files. The simulation calculation is performed.
         ii. The optimization engine automatically retrieves the output of the simulation package, checks to make sure results are within predefined constraints and stores the results in an output log.
         iii. The optimization engine then determines the new set of input parameters for the next run, utilizing the optimization algorithm to determine the lowest operational cost.
         iv. Once the lowest cost of operation is determined, the system setpoints associated with the lowest operational cost are delivered to the BAS or the AFDD platform OR a dedicated web page whichever the owner refers.
      c. Results of Optimization are then compared to costs associated with the historical profile in order to determine savings.

What is claimed is:

1. A building air-handling unit (AHU) total cost of operation optimization method, said method comprising the steps:
a. Providing a mathematical model of the air handling system including at least an efficiency profile of the components of the air handling system;
b. Obtaining real time weather information including at least outside temperature and outside humidity;
c. Obtaining Utility Rate Structure Pricing via Rate Engine;
d. Obtaining Normalized Annual Weather File for Location;
e. Obtaining Filter replacement Labor and Material Cost Schedule;
f. reading the AHU airflow (AF), prefilter pressure drop (PFPD), and final filter pressure drop (FFPD) of the respective Air Handling Unit (AHU);
g. Reading the PF, FF and any Tertiary Filter Replacemnt Dates;
h. periodically transferring the PFPD, FFPD, Tertiary Filter PD, and Airflow to an calculation engine preprocessor which will convert raw data into polynomial equations for the calculation engine to utilize;
i. periodically transferring the PF, FF and Tertiary Filter Replacement dates as well as the output of the preprocessing elements to an optimization system which is operative to analyze the data in coordination with the mathematical model by assigning at least three selected values in a range surrounding and including the current values of each of the projected prefilter and final filter replacement dates and calculating the efficiency profile of the component of the air-handling system for each of the selected values, then cooperatively optimizing and selecting those values calculated to provide the highest efficiency profile, then
j. periodically resetting the filter replacement dates to those selected by the optimization system;
k. Displaying annual projected savings;
l. Displaying realized savings;

2. The AHU total cost of operation optimization method of claim 1 wherein said mathematical model of the AHU system includes calculations of fan affinity laws and or fan energy equation and storage of filter change dates.

3. The AHU total cost of operation optimization method of claim 1 wherein said mathematical model of the AHU system includes filter loading profile.

4. The AHU total cost of operation optimization method of claim 1 wherein said mathematical model of the AHU system includes fan airflow profile.

5. The AHU total cost of operation optimization method of claim 1 wherein said step of analyzing said normalized annual weather data in coordination with said mathematical model by assigning at least three selection values in a range surrounding and including current values of PF and FF Replacement dates. And calculating the efficiency profile of the components of the AHU system for each of said at least three selected values for each of said PF and FF replacement dates.

6. The AHU total cost of operation optimization method of claim 1 wherein the step of periodically resetting each of said filter change dates to said values selected by said optimization engine further comprises resetting each of said filter change dates to said filter change dates to said values optimization engine monthly.

7. The AHU total cost of operation optimization method of claim 1 wherein the said normalized weather information comprises predicted weather information for obtaining mid to long term operational efficiency forecasts for operational planning purposes.

8. The AHU total cost of operation optimization method of claim 1 wherein the said filter replacement dates are cooperatively optimized.

9. The AHU total cost of operation optimization method of claim 1 further comprising the steps of obtaining and analyzing real-time utility cost information.

10. The AHU total cost of operation optimization method of claim 9 wherein said preprocessing of the real time utility cost information and Weather Data generates a utility regression based on time of day and Weather which is then used by the calculation engine when that particular mode of operation is chosen for optimization.

11. The AHU total cost of operation optimization method of claim 1 further comprising the steps of obtaining and analyzing Utility Renewable Percentage information.

12. The AHU total cost of operation optimization method of claim 11 where a custom incentive can be introduced into the system to realize a credit for increased use of renewable energy.

13. The AHU total cost of operation optimization method of claim 1 further comprising the steps of obtaining and analyzing Emergency Power Profile.

14. The AHU total cost of operation optimization method of claim 13 where an owner defined benefit can be introduced into the system to realize the advantages of decreasing load on site emergency generators.

15. The AHU total cost of operation optimization method of claim 1 further comprising the steps of taking Weather Data used for Fan airflow regression and Utility Regression and compiling it into a Historical Weather file that can be used by the calculation Engine to perform risk analysis when comparing the optimization of an Normalized File and a chronological weather file.

16. The AHU total cost of operation optimization method of claim 1 further comprising the steps of obtaining Filter Pressure Drop by means of other than direct measurement by a BMS.

17. The AHU total cost of operation optimization method of claim 16 Virtual AHU Airflow Calculation Method #1: In the absence of direct measurement of AHU airflow at the AHU itself, the sum of all of the Air Terminal Unit Airflow sensors may be used as a substitute.

18. The AHU total cost of operation optimization method of claim 16 Virtual AHU Airflow Calculation Method #2: In the absence of direct measurement of AHU airflow the combination of gathering the fan RPM as reported by the VFD via the BMS and the addition of a differential pressure sensor across the supply fan will yield fan flow.

19. The AHU total cost of operation optimization method of claim 1 further comprising the steps of obtaining Fan Airflow by means of other than direct measurement by a BMS.

20. The AHU total cost of operation optimization method of claim 19 Virtual Differential Pressure Calculation Method #1: When BAS is configured with a differential pressure gauge with binary output that indicates when differential pressure has met a specific setpoint. The setpoint on the gauge shall be set at intermediate points and when the point is detected as being met it is so noted by the system and the setpoint is raised in the field to a new intermediate setpoint

21. The AHU total cost of operation optimization method of claim 19 Virtual Differential Pressure Calculation Method #2: When BAS is not connected to filters in any way it is possible to measure the pressure gauge 1 time per week and match it up with concurrent AHU airflow and through a calculation come up with a virtual pressure drop at the higher time frequency. The measurement of 1× per week would be done during maintenance department “rounds” using custom designed smartphone app that would streamline data acquisition. Each gauge not hooked to the BMS would receive a QR or Barcode at the project setup. Once scanned during “rounds” the code would bring up a form for the maintenance technician to enter the current pressure measurement. This reading would then be transferred to a database capable of being uploaded to the filter loading curve preprocessing element.

22. The AHU total cost of operation optimization method of claim 19 Virtual Differential Pressure Calculation Method #3: When BAS is not connected to filters in any way but has a digital readout it is possible to measure the pressure gauge by taking a picture of the gauge with a smartphone and then doing image processing to read the QR or bar code to get the meter metadata and have an Optical Character Recognition Software to batch process the images to read the values.

23. The AHU total cost of operation optimization method of claim 19 Virtual Differential Pressure Calculation Method #4: When BAS is not connected to filters in any way but has an analog readout it is possible to measure the pressure gauge by taking a picture of the gauge with a smartphone and the doing image processing to read the QR or bar code to get the meter metadata and have the same image processor to batch process the images to read the data.
